(19) United States
(12) Patent Application Publication
(10) Pub. No.: US 2010/0181400 A1
(43) Pub. Date: Jul. 22, 2010

(54) BIN LIGHT FOR MEDIA SHREDDER

(75) Inventors: Josh Davis, Hudson, OH (US); Jeffery Jensen, Hudson, OH (US); Zhiguo Li (Henry) Zhi Guo, DongGuan City (CN); Hua (Kevin) Ren, DongGuan City (CN)

Correspondence Address: FAY SHARPE LLP, 1228 Euclid Avenue, 5th Floor, The Halle Building, Cleveland, OH, 44115, US

(73) Assignee: TECHTRONIC FLOOR CARE TECHNOLOGY LIMITED

(21) Appl. No.: 12/687,317

(22) Filed: Jan. 14, 2010

Related U.S. Application Data
(60) Provisional application No. 61/145,580, filed on Jan. 18, 2009.

(51) Int. Cl. B02C 19/00

(52) U.S. Cl. 241/100; 241/101.2

(57) ABSTRACT

A fragmentation device includes a bin formed from at least one continuous wall extending upwardly from a bottom surface. A containment space is defined by the at least one wall and the bottom surface. An adjacent fragmentation assembly is situated adjacent to an entrance of the bin. An illumination means is situated in proximity to an exit slot of the fragmentation assembly and the entrance of the bin. The illumination means directs at least one light beam downwardly into the containment space. A controller actuates the illumination means when a mechanical system contained in the fragmentation assembly is energized. In another embodiment, the controller actuates the illumination device when a sensor detects a presence of an article entering the fragmentation assembly.

This application claims the benefit of priority to U.S. Provisional Patent Application No. 61/145,580, filed Jan. 18, 2009, entitled “BIN LIGHT FOR SHREDDERS OF SHEET LIKE MATERIAL”, by Josh Davis, et al., the disclosure of which is hereby incorporated by reference in its entirety.

### BACKGROUND

The present disclosure is directed toward a means for determining a capacity of a bin containment space and, more specifically, to an illumination means that automatically energizes for periods of which an article pile is being built therein a bin by an adjacent mechanical system.

There is known a plurality of article destruction appliances including a mechanical system that manipulates an introduced article before emptying a transformed article into a communicating region. In media shredder devices, for example, the mechanical system includes a counter-rotating cutter assembly, which fragments media and empties the resulting chad into a communicating bin receptacle. In trash compactor devices, for example, the mechanical system includes a hydraulically powered plate, which crushes refuse and compacts the reduced volume in a communicating compartment.

The foregoing communicating region only functions as a temporarily containment for the article(s). The article(s) are generally emptied therefrom for a more permanent disposal. If the articles are not emptied from the device when the containment space is full to capacity, a growing pile or volume can backup into the mechanical systems and cause a jam.

There is a plurality of known means incorporated in destruction devices to monitor and/or detect bin capacity (fullness) level(s). One example includes a mechanical switch that actuates when a predetermined weight of a media pile moves an actuating lever from a first position to a second position. One aspect associated with this switch-type mechanism is that bin fullness detection is based on weight. Known shredder devices, for example, are capable of shredding media of various materials including plastics (credit cards), metals (storage discs, DVDs, CDs), and paper (documents) having varying weights per unit of volume. Heavier materials may tend to prematurely actuate the switch when a chad pile is only occupying a fraction of the entire containment space. In this manner, the shredder device may falsely conclude that the bin full condition is met.

An alternative feature utilized in shredder devices to detect a full bin capacity is a level or optical sensor situated within the bin containment space. More specifically, a transmitter component generates a focus beam across the containment space. The focus beam is interrupted when a growing chad pile reaches a height that is associated with a full bin. A receiver sends a signal to a controller, which activates an indicator on a display, such as, for example, a message, a blinking light, or a colored light. This indicator is aimed to warn a user of an oncoming fault condition (s.a., a jam) if the bin receptacle is not emptied. In some known devices, the controller will de-energize the mechanical systems.

While level sensors are generally very reliable, they may still result in false readings on occasion. Routinely introduced in a marketplace are a number of appliances that include sophisticated and advanced features aimed to decrease consumer action and/or save consumer time. One aspect of these features, such as, level sensors, is that they can make an appliance more complex, thus making the appliance more difficult to use or the detector more difficult to remedy during instances when a falsely detected condition makes the mechanical systems inoperative. In this manner, the device is neither easier nor less timely to use.

In the destruction devices that utilize indication systems, an operator is made aware of a detected bin fullness condition by visually viewing the indication in the form of a warning on the display. It is contemplated herein that the same bin capacity condition can be observed by a user provided with viewable access to the article pile itself. It is therefore anticipated the pile may be made viewable to a user, instead of a display, for assisting in a conclusion that the bin capacity condition and/or threshold is met.

Another aspect associated with the appliances including additional or more complex default detection components is that a cost of manufacturing is driven higher. A destruction appliance is therefore desired which utilizes less complex means to detect bin capacity levels and fullness. A destruction device is disclosed herein which minimizes the electrical sensor and indication components, thus lowering both manufacturing and retail costs without compromising an efficiency of the intended destroying function of the device.

### BRIEF DESCRIPTION

One embodiment associated with the present disclosure includes a fragmentation device including a bin formed from at least one continuous wall extending upwardly from a bottom surface. A containment space is defined by the at least one wall and the bottom surface. An adjacent fragmentation assembly is situated adjacent to an entrance of the bin. An illumination means is situated in proximity to an exit slot of the fragmentation assembly and the entrance of the bin. The illumination means directs at least one light beam downwardly into the containment space.

Another embodiment associated with the present disclosure is directed toward a shredder appliance for shredding at least one generally planar media sheet. The shredder appliance includes a containment space formed by a bottom wall and at least one generally upwardly extending sidewall connected thereto. At least one transparent region is formed through the at least one wall. The shredder further includes a head assembly having a cutter assembly and a drive assembly. The cutter assembly includes at least one cutter for shredding the media sheet. The drive assembly is for translating movement of the at least one cutter. A feed path extends from an exterior of the head assembly to the bin. The feed path includes a feed slot portion for introducing the media sheet to the cutter assembly. The feed path extends adjacent to the at least one cutter. The feed path then terminates at an opening to the bin. A light selectively activates to illuminate the bin for a duration at least simultaneous to when the drive assembly is energized.

In a further embodiment associated with the present disclosure, a media shredder device includes a bin having a closed containment space defined by a bottom wall and at least one sidewall extending upwardly therefrom. An access to the containment space is situated at a height generally above the sidewall. An LED illuminate is situated above the containment space and in proximity to the access. The LED illuminant selectively emits light downwardly into the containment space. The LED illuminate operates at a wavelength of at least 440 nanometers.

### BRIEF DESCRIPTION OF THE DRAWINGS

FIG. 1 illustrates a frontal view of a shredder device according to one embodiment of the disclosure;

FIG. 2 illustrates a perspective view of a support housing for the shredder device shown in FIG. 1;

FIG. 3 illustrates a perspective view of a bin receptacle for the shredder device shown in FIG. 1;

FIG. 4 illustrates a top view of a core mount assembly included in the shredder device for supporting mechanical systems housed therein;

FIG. 5 illustrates an underside view of a head assembly included in the shredder device shown in FIG. 1; and,

FIG. 6 illustrates a top view of the bin receptacle shown in FIG. 4.

### DETAILED DESCRIPTION

Applications of the present disclosure are intended for inclusion in article destruction devices, wherein at least one driven mechanical component operates on a foreign article. The present disclosure is more specifically intended for destruction appliances that receive a foreign article in a first form and manipulate the article to a second form, which may be unreadable or unrecognizable. The article destruction devices disclosed herein include at least one mechanical system housed in a head assembly and at least one containment compartment situated adjacent thereto. The foreign article is received in a throat situated on the head assembly for guiding the article from an exterior of the device to the mechanical system(s). The mechanical system includes at least one piercing mechanism that can fragment the article into multiple units, or it can consolidate the article to a compressed volume. The head assembly is positioned in proximity to the containment space such that the transformed article is moved from the mechanical system to the containment space. The present disclosure is directed toward a means for detecting a decreasing volume of the containment space that the transformed article is occupying as it is being received within the containment space. More specifically, the present disclosure is directed to an illumination means that illuminates the containment space during simultaneous periods of which the mechanical system(s) is energized. In this manner, the illumination means assists a user in making a visual determination for when a capacity of the containment space is full.

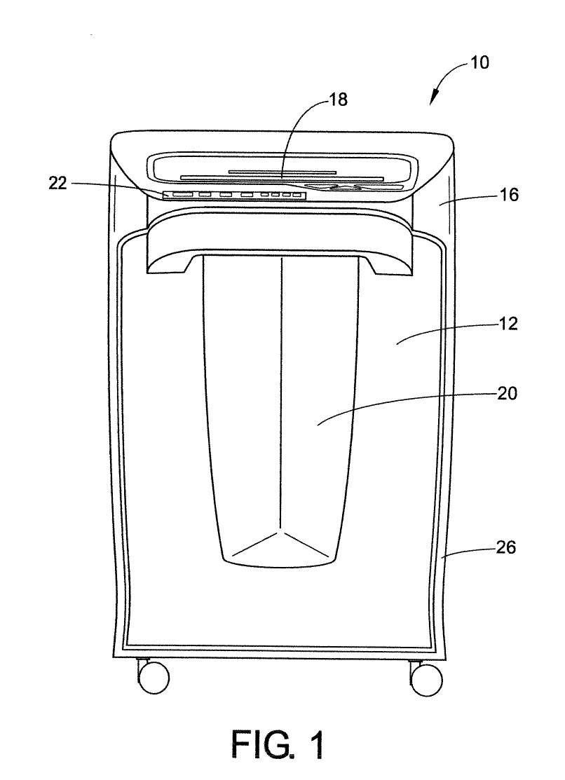

One article destruction device contemplated for use with the present disclosure is a fragmentation device, such as, for example, a shredder appliance 10. FIG. 1 illustrates a frontal view of the shredder device 10 including a removable bin receptacle 12 having a containment space 14 (see FIG. 3) for temporarily housing chad. The bin receptacle 12 is situated adjacent to a head assembly 16. In the illustrated embodiment, the bin receptacle 12 is situated underneath the head assembly 16, which contains all of the mechanical and electrical systems of the shredder device 10, such as, for example, a motor drive and cutter assembly. More specifically, media is inserted into a feed slot 18 situated on the head assembly 16 for providing access to the mechanical shredder systems. The feed slot 18 directs the media to a later discussed mechanical shredding system, and then the chad formed therefrom empties into the containment space 14 of the bin receptacle 12. In the disclosed embodiment, a later described transparent region 20 is situated on at least one sidewall portion defining the bin receptacle 12. A display 22 can include various indicator means that may activate when a certain operational mode is met. When the bin receptacle 12 is full of chad, the contents must be emptied into a separate trash receptacle. The present disclosure is directed toward cooperating features that assist in determining when emptying of the bin receptacle 12 is recommended or necessary.

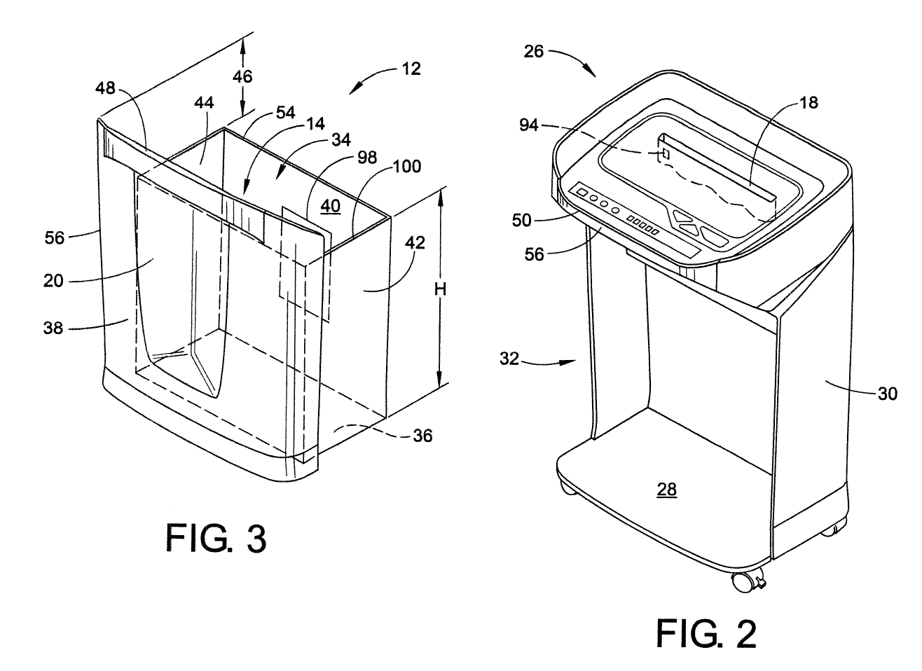

In the illustrated shredder embodiment of FIG. 1, the bin receptacle 12 separates from the head assembly 16 when the bin 12 is to be emptied. A handle 24 is situated on an outer surface of the bin receptacle 12 for assisting in removably separating the 12 bin from the head assembly 16. This handle 24 is illustrated as protruding outwardly from a front face of the shredder device 10 and, more specifically, from a front face of the bin 12. Force pulling on the handle 24 removes the bin receptacle 12 away from the head assembly 16 (as is shown in FIGS. 2 and 3). It is anticipated that when the bin receptacle 12 is removed, the head assembly 16 may remain suspended at the same height and position by means of a support body or similar performing structure. This support body may be, for example, a cabinet 26 as illustrated in FIG. 2. The cabinet 26 may include a support floor 28 and/or at least one non-continuous cabinet wall 30 extending upwardly therefrom. The at least one non-continuous cabinet sidewall 30 generally corresponds in dimension to an outer surface portion of the bin receptacle 12 that is received adjacently therein the cabinet 26. The cabinet 26 includes an access 32 formed between terminal ends of the at least one non-continuous cabinet sidewall 30. This access 32 is more specifically a cavity that receives the bin 12. This access 32 provides removeable placement of the bin 12 in the cabinet structure 26.

Other support structures are contemplated to include, for example, posts, or a pair of generally planar opposing walls, etc. that extend upwardly from the support floor 28. In this manner, the bin receptacle 12 is removably housed in a shredder device structure 10. In one embodiment, the bin receptacle 12 may not separate from the head assembly 16 when the chad contained therein is emptied to a waste receptacle. Rather, the head assembly 16 mounts to an adjacent portion of the bin receptacle 12. In these anticipated more compact and lighter construction embodiments, the entire shredder unit 10 is carried over to and maintained above the waste receptacle for emptying. In this manner, the handle 24 on the front face of the bin 12 is used to support the entire shredder device 10 as a panel (not shown) situated on the bin receptacle 12 pivots from a first position to a second position, thus opening access to the bin 12 for emptying.

The cabinet 26 and the bin receptacle 12 are illustrated in FIGS. 2 and 3, respectively. The cabinet 26 supports the head assembly 16 above the cavity region 32 of which the bin receptacle 12 is received. It is anticipated that generally planar media sheet(s) are inserted into the shredder device 10 at the feed slot 18. The media sheet passes through at least one moving mechanical component situated in the head assembly 16 before the chad formed therefrom is emptied into the bin 12. The bin receptacle 12 is therefore illustrated in FIG. 3 to include an opening 34 situated in general proximity to the lowermost portion of the head assembly 16. This opening 34 provides access to the generally closed containment space 14.

The bin receptacle 12 of FIG. 3 includes a bottom wall 36 that is supported by the cabinet floor 28 when the bin receptacle 12 slides into the cabinet 28 to rest under the head assembly 16. The bottom wall 36 supports a pile of chad built thereon as it falls from the header assembly 16. At least one continuous wall extends upwardly from a perimeter of the bottom wall 36. FIG. 2 shows a pair of oppositely extending longitudinal walls 38, 40 connected by a pair of oppositely extending lateral walls 42, 44. There is no limit made herein to a number and to a length of connected walls. In the present embodiment, for example, the lateral walls 42, 44 can be equal or unequal to the longitudinal walls 38, 40 in length.

In the illustrated embodiment, a first in the pair of longitudinal walls 38 (hereinafter synonymously referred to as “front sidewall”) may include an extension portion 46 that extends beyond a top perimeter 54 of a second (opposing “rear sidewall”) 40 in the pair of longitudinal walls. The extension portion 46 makes the front sidewall 38 taller than the second longitudinal wall 40. In this manner, the extension is not received in the cavity 32 of the cabinet 26; rather, a top perimeter 48 of the extension portion 46 meets a front edge 50 of a top face 52 of the head assembly 16. The extension portion 46 furthermore extends beyond a length of the front sidewall 38 and wraps around a corner 56 formed between the terminal ends of the front sidewall 38 and corresponding terminal ends of the first and second lateral wall 42, 44. In this manner, the extension portion 46 forms a limited front length portion of the lateral walls 42, 44.

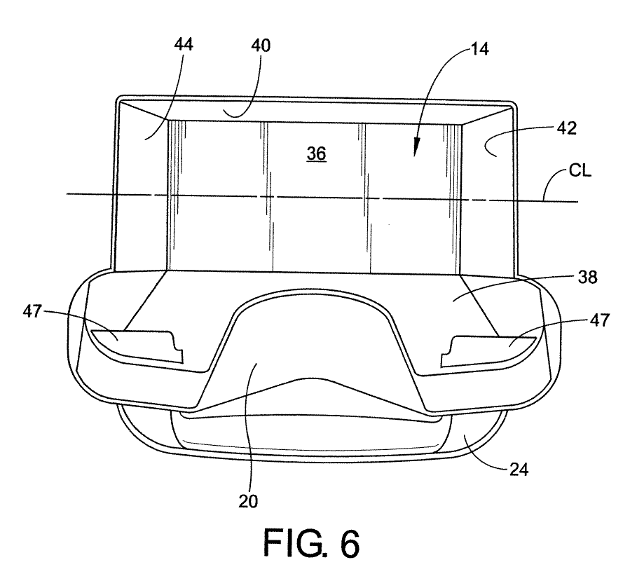

The extension portion 46 may generally be considered as starting at inwardly projecting flanges 47 (see FIG. 6) situated coincident to the plane extending across the bin receptacle 12 and, more specifically, coincident with a top perimeter 54 of the containment space 36 formed between the walls 40-44. These flanges 47 can fit or be received into arrangement under a corresponding undersurface of the head assembly 16 when the bin receptacle 12 is inserted into either the cabinet 26 or another head support body structure of the shredder device 10. These flanges 47 can alternatively support the head assembly 14 for embodiments of which the head assembly 14 mounts to the support member 32, and the entire shredder device 10 is thus carried to the waste receptacle.

The handle 24 is shown as being integrally connected to an outer face of the extension portion 46 such that it is connected to the bin receptacle 12 at a height that is beyond a top perimeter 54 of the walls 40-44 forming the containment space 14 (hereinafter synonymously referred to as “collection portion”) of the bin receptacle 12. This collection portion 14 is more specifically the volume and/or containment space 14 made available for collecting chad. Therefore, a top height H of the collection portion 14 is situated in a plane coincident with the top edge 54 of the second longitudinal wall 40. The handle 24 is illustrated in the present embodiment as being generally horizontal in orientation, i.e., parallel to the support floor 28.

One feature of the present means for detecting bin capacity is illustrated in FIG. 3. Situated on the front sidewall 38 is the transparent surface region 20. More specifically, the transparent surface region 20 can include a window. The transparent surface region 20 is formed of any material that provides for a passage of light from inside the bin (i.e., the bin containment space 14) toward an exterior of the bin receptacle 12. In one embodiment, the transparent surface region 20 is formed of a transparent and durable plastic material. It is anticipated that the transparent surface region makes the chad contents contained in the bin receptacle 12 viewable without requiring that the bin receptacle 12 be moved away a distance from the head assembly 16 for a peak therein at the opening 34.

There is no limitation made herein to a method of connecting the transparent surface region 20 to the front sidewall 38. In one embodiment, the transparent surface region 20 may be formed integral with the front sidewall 38. In one embodiment, the transparent surface region 20 can be bonded to the front sidewall 38. In one embodiment, the transparent surface region 20 can be attached to the front sidewall 38 by means of at least one mechanical fastener.

In one embodiment, the present transparent surface region 20 includes a surface area dimension that covers at least one-quarter (¼) of the front sidewall 38. In one embodiment, the transparent surface region 20 includes a surface area dimension that covers at least one-half (½) of the front sidewall 38. In one embodiment, the transparent surface region 20 includes a surface area dimension that covers at least three-quarters (¾) of the front sidewall 28. In this manner, a great volume of the containment space 14 is made viewable without (1) moving the bin receptacle 12 and (2) spilling of fragments from the bin receptacle 12. It is alternatively contemplated that an entire surface region of the front sidewall 38 be formed of the transparent material.

As previously described, the extension portion 46 causes the front sidewall 38 of the bin receptacle 12 to be taller than the top perimeter 54 of the containment space 36. One aspect of this taller front sidewall 38, 40 is that it increases the surface area portion available for the transparent surface region 20. One aim for detecting bin fullness capacity is to prevent a jam of mechanical systems resulting from backflow of chad. A transparent surface region 20 is therefore desirable for viewing the topmost regions of the containment space 36. The taller front sidewall 38 of the present disclosure provides a surface capable of including a transparent surface region 20 that extends beyond the top edge 54 of the containment space 14. In the illustrated embodiment, a top portion of the transparent surface region 20 rests adjacent to a front housing of the head assembly 16 when the bin receptacle 12 is received in the cabinet 26.

In one embodiment, a top perimeter 58 of the transparent surface region 20 can be coincident with a plane extending across the opening 34 of the bin receptacle 12. There is, however, no limitation made herein to a surface portion of the front sidewall 38 of which the transparent surface region 20 is situated. In one embodiment, for example, the transparent surface region 20 can be situated in a middle surface portion of the front sidewall 38.

There is also no limitation made herein to a general shape and dimension of the transparent surface region 20. In one embodiment, at least a portion of the transparent surface region 20 may be generally flush with the front sidewall 38. In one embodiment, the transparent surface region 20 may be generally planar. One aspect of the generally planar transparent surface region 20 is that the user is provided with an unobstructed view of the entire containment space. In one embodiment, at least a portion the transparent surface region 20 may protrude outwardly from the front sidewall 38. One aspect of the outwardly protruding transparent surface region 20 is that it does not occupy any available region of the containment space 14, thus providing for a maximum volume of contents to be temporarily stored therein. In one embodiment, at least a portion of the transparent region 20 can depart inwardly from the front sidewall 38. One aspect of the inwardly departing transparent surface region 20 is that it enables a user to get a closer view of the inner containment space 14 regions of the bin receptacle 12.

It is anticipated that the non-flush embodiments of the transparent surface region 20 not be limiting to any one dimension. It is anticipated, for example, that the transparent surface region 20 be generally curved (arcuate) in some embodiments such that it is similar to a bubble. In another embodiment, the transparent surface region 20 can include at least a first inwardly angled surface portion that intersects and or meets at least a second inwardly angled surface portion, wherein at least the first and second inwardly angled surfaces portions start at oppositely extending perimeter portions of the transparent surface region 20. At least a third surface portion can similarly extend inwardly from a perimeter portion connecting the oppositely extending perimeter portions. In another embodiment, the transparent surface region 20 can include at least a first outwardly angled surface portion that intersects and or meets at least a second outwardly angled surface portion, wherein at least the first and second outwardly angled surface portions start at oppositely extending perimeter portions of the transparent surface region 20. At least a third surface portion can similarly extend outwardly from a perimeter portion connecting the oppositely extending perimeter portions.

There are no limitations made herein to the transparent surface region 20 with exception that such transparent surface region 20 make viewable the contents stored within the containment space 14. As previously articulated, the bin receptacle 12 is situated adjacent to the head assembly 16. More specifically, the opening 34 to the bin receptacle is situated adjacent to and beneath the head assembly 16. Chad falls directly from the head assembly 16 into the bin 12 immediately after the media passes through at least one mechanical system.

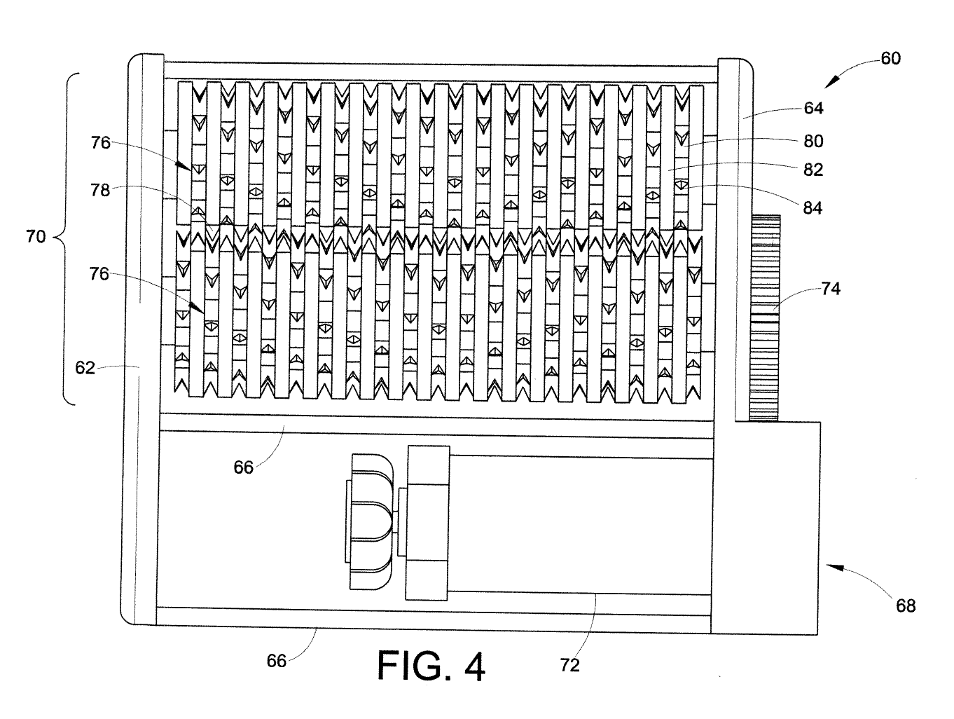

The head assembly 16 houses both the mechanical and electrical systems of the shredder device 10. More specifically, these mechanical and electrical systems are supported by a core mount assembly 60 that is housed in the closed head assembly 16. FIG. 4 illustrates a top view of the core mount assembly 60. The core mount assembly 60 is formed of a first mount support member 62 opposite and spaced apart from a second support member 64. The first and second support members 62, 64 can comprise a wall having a generally first planar face (hereinafter synonymously referred to as “surface”) opposite a generally second planar face. The support members 62, 64 can alternately comprise elongate bars having at least a generally planar inner face or surface at the inward orientation. The core mount assembly 60 can further include at least one fixed third support member 66 situated between and transverse to the first and second support members 62, 64. The third support member 66 is shown in the illustration as a rod; however, a generally planar wall and other support structures are contemplated. In one embodiment, three generally parallel rods 66 connect the first support member 62 to the second support member 64. These rods 66 also segment a compartment containing a locomotive device 68 (hereinafter synonymously referred to as “motor assembly”), which is spaced apart from and drives a later described cutter assembly 70.

The locomotive device 68 can include any known drive assembly. In one particular embodiment, the locomotive device 68 as illustrated in FIG. 4 includes a motor 72 and one or more gears 74. The gears 74 drive rotation of the cutting assembly 70 in forward and/or reverse directions. The cutting assembly 70 includes at least one elongate cutting cylinder 76. The cutting assembly 70 is illustrated to include two elongate cutting shafts 76 situated in a parallel relationship that defines a feed gap 78 (i.e., a feed slot portion) formed between the innermost adjacent circumferential surfaces of the cutting cylinders 76. Each of the two cutting cylinders 76 is rotatably mounted at terminal ends to the first and second support surfaces 62, 64. In one embodiment, a set of combs or tines (not shown) can extend inwardly from the third support surfaces 66 toward the cutting cylinder(s) 76. In one contemplated embodiment, only one cutting cylinder 76 can be work in conjunction with one set of combs to achieve a destroying of the media fed into the device 10.

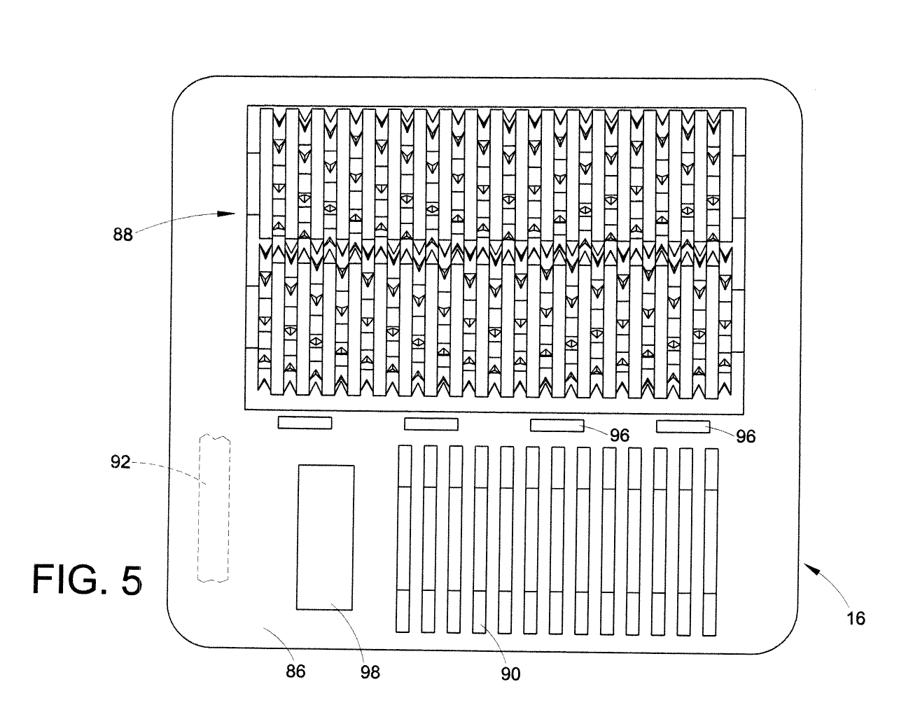

At least one of the cutting cylinders 76 includes a plurality of spaced apart cutter discs 80. The cutter discs 80 are illustrated in FIGS. 4 and 5 to be situated in alternating fashion with spacer discs 82. The spacer discs 82 prevent fragments of media from collecting in the spaces between the cutter discs 80. As is illustrated in the figures, blades or teeth 84 may be incorporated on the cutting cylinders 76.

In the present embodiment, a limited circumferential extent portion of the counter-rotating cutting cylinders 76 is the only component of the core mount assembly 60 not completely covered by the housing of the head assembly 16. FIG. 5 illustrates an undersurface or bottom face 86 of the head assembly 14. This bottom face 86 is oriented toward and adjacent to the opening 34 of the bin receptacle 12 when the shredder device 10 is operational. As is illustrated in the figure, an aperture is formed through the undersurface 86. This aperture defines an exit slot 88 for chad to empty into the bin receptacle 12 after the media is fed between the inner (adjacent) circumferential portions of the cutting cylinders 76. The cutting cylinders 76 are situated generally above a first half surface portion of the undersurface 86. A motor cooling vent 90 is situated through a portion of a second half surface region of the undersurface 86. More specifically, the vent 90 is situated below the motor 72 to prevent a potential overheating of the motor 72.

Circuitry for the shredder device 10 may be situated above the undersurface 76 about a surface region adjacent to the cutting cylinders 76 and the motor 72. A controller 92 is included in the circuitry. The controller 92 is operatively associated with the motor assembly 68 for commanding forward and reverse rotations of the cutting cylinders 76. The controller 92 may further be operatively associated with a sensor 94 (see FIG. 2) situated in proximity to an entrance of the feed slot 18 for detecting a presence of an article or media being fed into the shredder device 10. The controller 92 may be programmed to energize the mechanical systems (68, 70) when the sensor 94 detects media in the throat (i.e., feed slot) 18 of the head assembly 16.

The controller 92 energizes the motor 72 to drive the counter-rotating cutting cylinders 76 in a forward direction when media enters the feed slot 18 or when the shredder device 10 is powered on. The forward rotating cutting cylinders produce an effect of pulling the media between them and urging it downwardly through the exit slot 88. The chad falls from the exit slot 88 into the bin receptacle 12. More specifically, a pile of chad will build on the bottom wall 36 of the bin receptacle 12, and the chad will be contained within the space 14 of the bin 12 by means of the sidewalls 38-44. As previously described, the growing chad pile can be viewed through the transparent surface region 20 feature of the present shredder device 10.

Another feature of the present disclosure includes an illumination means 96 that illuminates the containment space 14 of the bin receptacle 12. More specifically, the illumination means 96 selectively illuminates the containment space 14 so that viewing of the chad pile inside the bin 12 is made easier. In one embodiment of the disclosure, the illumination means 96 includes at least one light emitting diode (LED); however, there is no limitation made herein to a type of illuminator device used to selectively light the containment space 14. Any illumination means 96 may be utilized that does not present a potential risk of catching or starting fire to any paper or other material of media chad contained therein the bin 12.

The illumination means 96 is operatively associated with the controller 92. In one embodiment, the controller 92 may selectively illuminate the illumination means 96 for at least a duration simultaneous to when the motor drive assembly 68 is energized. In another embodiment, the controller 92 selectively illuminates the illumination means 96 for at least a duration simultaneous to when the sensor 94 detects a presence of media in the throat 18. In one embodiment, the controller 92 selectively activates the illumination means 96 when the sensor 94 generates a signal indicating a presence of the media introduced in the feed slot 18. The controller 92 may then continue illumination of the illumination means 96 for the duration that the motor assembly 68 remains energized. In one embodiment, the controller 92 may be programmed to continue an illumination of the illumination means 96 for a predetermined period after the motor assembly 68 de-energizes so that the user can view the containment space 14 after all the media that was shred falls into the pile growing in the bin receptacle 12. In another contemplated embodiment, an activation switch, button, knob, or similar performing manual selection component situated on the display 22 (see FIG. 1) can provide the user with selective activation of the illumination means 96. The user can therefore selectively illuminate the containment space 14 for viewing inside the bin receptacle 12 even during periods when the motor assembly 68 is suspended and/or off. In one embodiment, the controller 92 can be programmed to activate the illumination means 96 in response to user selection on the display 22. In one embodiment, the controller 92 can maintain the illumination means 96 in the activated state until the user selects for the illumination means 96 to be deactivated. In another embodiment, the controller 92 can maintain that the illumination means 96 illuminate the bin receptacle 12 for a predetermined duration after the user selects a display option for illuminating the containment space 14.

There is no limitation made herein to the operative features of the illumination means 96. In one embodiment, the LED illumination means 96 can operate in a wavelength range at least greater than 400 nanometers. In one embodiment, the LED illumination means 96 can operate in a wavelength range of at least less than 490 nanometers. In one embodiment, the LED illumination means 96 can operate at a wavelength range of from about 440 nanometers to about 490 nanometers. In one embodiment, the LED illumination means 96 can operate at a wavelength range of from about 490 nanometers to about 550 nanometers. In one embodiment, the LED illumination means 96 can operate at a wavelength range of from about 550 nanometers to about 4700 nanometers. In one embodiment, the LED illumination means 96 can operate at a wavelength range of from about 580 nanometers to about 630 nanometers. In one embodiment, the LED illumination means 96 can operate at a wavelength range of from about 630 nanometers to about 700 nanometers.

In one embodiment including one illumination means 96, the illumination means 96 can operate at a hue value of 240-degrees. In another embodiment, at least one illumination means 96 operates at a hue value of approximately 240-degrees. In another embodiment including multiple illumination means 96, at least one illumination means 96 can operate at a hue value of approximately 240-degrees. In another embodiment including multiple illumination means 96, each one of the multiple illumination means 96 can operate at a hue value of approximately 240-degrees. There is no limitation made herein, however, to the hue value of LEDs utilized in the present disclosure. An LED can include any hue value that functions to illuminate the LED in a visible color spectrum. In one embodiment including one LED illumination means 96, the LED can be blue. In another embodiment, at least one LED illumination means 96 may be blue. In another embodiment including multiple LED illumination means 96, at least one LED is blue. In another embodiment including multiple LED illumination means 96, each one of the multiple LEDs may be blue. There is no limitation made to the color any one LED includes in the present disclosure. In other embodiments, at least one LED can be generally green in color, generally yellow in color, generally orange in color, etc. It is anticipated that any one LED included in the present illumination means 96 can include any color in the visible spectrum which achieves to pass light through the transparent surface region 20 and enable well illuminated viewing of contents within the bin containment space 14.

There is hence no limitation made herein to a color, a hue value, or a wavelength range of which the present illumination means 96 operates. It is anticipated, for example, that embodiments including multiple illumination means can include at least two illumination means 96 of different colors and operating at different hue values and wavelength ranges. One embodiment is contemplated, for example, to include multiple indication means 96, wherein each one of the multiple illumination means 96 is independently controlled by the controller 92. More specifically, the multiple illumination means 96 can work as a progressive illumination system, wherein a first one of the multiple illumination means 96 illuminates at a first color, hue value, or wavelength when the sensor 94 detects presence of media in the feed slot 18 and at least a second illumination means 96 illuminates at a second color, hue value, or wavelength when the motor is energized. The first color may be different than the second color. The first hue value may be different from the second hue value. The first wavelength may be unequal to the second wavelength. In one embodiment, at least a third illumination means 96 may illuminate at a third color, hue value, or wavelength for a predetermined period after the motor de-energizes.

In another contemplated progressive illumination system embodiment, it is anticipated that a first one of the multiple illumination means 96 illuminates at a first color, hue value, or wavelength when the bin receptacle 12 is at a first capacity and at least a second illumination means 96 illuminates at a second color, hue value, or wavelength when the bin receptacle 12 is at a second capacity. For example, the first capacity may be associated with an empty containment space 14. The second capacity may be associated with a partially full capacity. A third illumination means 96 may illuminate at a third color, hue value, or wavelength when the bin receptacle 12 is at full capacity. The first color may be different than the second color. The first hue value may be different from the second hue value. The first wavelength may be unequal to the second wavelength. In operation, it is anticipated that the shredder device 10 would include known bin capacity detectors operatively associated with the controller 92. In this manner, the present bin capacity detection means (i.e., illumination means 96 and transparent surface region 20) would work in cooperation with known sensors and switches, wherein the controller 92 would alternatively activate one of the illumination means 96 disclosed herein instead of activating an indication warning on the head assembly display 22.

In a further contemplated embodiment of the present disclosure, the present bin illumination system can work in conjunction with at least one other bin capacity system. For example, as disclosed herein, the illumination means 96 activates during at least durations of which the motor 72 is engaged and/or at least durations of which media is detected in the feed slot 16. However, a level sensor (not shown), for example, can be included in the containment space 14 of the bin receptacle 16, wherein the level sensor is operatively associated with the controller 92 for activating an indication (visual or audio) to warn the user when the bin is at or near full capacity. In this manner, activation of the indicator may warn a user that the bin is full, and the visual illumination means 96 and transparent surface region 20 features of the present disclosure will assist the user in making a visual determination and/or confirmation of the same.

In one embodiment, a region situated on an inner face of at least one sidewall 38-44 may include a reflective surface 98 (see FIG. 3) to amplify the illumination means 96. In one embodiment, a region situated on the bottom face 86 of the header assembly may alternatively or additionally include the reflective surface 98 for purposes of amplifying the illumination means 96.

It is anticipated that the present disclosure includes at least one illumination means 96 situated in proximity to the exit slot 88 portion of the feed path 78 and the opening 34 of the bin receptacle 12. In the embodiment illustrated in FIG. 5, the illumination means 96 is situated on the bottom face 86 of the head assembly 16. In one embodiment (not shown) the illumination means 96 can be situated on the inner face of at least one sidewall 38-44. More specifically, the illumination means 96 can be situated in proximity to the top edge 54 of the second longitudinal sidewall 40 and/or in proximity to the similar top edge portion 100 of at least one of the first and second lateral sidewalls 42, 44. It is anticipated that the illumination means 96 be positioned to direct light downwardly toward the bottom wall 36 such that a top of the building chad pile is made more easily viewable through the transparent surface region 20. It is anticipated that the illumination means 96 be situated in a position where it is capable of at least illuminating a region of the containment space 14 situated behind or adjacent to the transparent surface region 20.

Referring to FIG. 5, at least one illumination means 96 is positioned on an undersurface 86 of the head assembly 16 between the exit slot 88 and the motor cooling vent 90. This illumination means 96 extends along at least a longitudinal extent portion of the exit slot 88. In one embodiment, one illumination means 96 can extend along at least a middle length portion of at least one longitudinal side situated adjacent to the exit slot 88. In one embodiment, one illumination means 96 can extend along at least a majority length portion of at least one longitudinal side situated adjacent to the exit slot 88. In one embodiment, one illumination means 96 can extend along an entire length portion of at least one longitudinal side situated adjacent to the exit slot 88. In one embodiment, multiple illumination means 96 can be spaced apart to extend along at least a middle length portion of at least one longitudinal side situated adjacent to the exit slot 88. In one embodiment, multiple illumination means 96 can be spaced apart to extend along at least a majority length portion of at least one longitudinal side situated adjacent to the exit slot 88. In one embodiment, multiple illumination means 96 can be spaced apart along an entire length portion of at least one longitudinal side situated adjacent to the exit slot 88.

There is no limitation made herein to a location and to a number of illumination means 96 situated in proximity to the exit slot 88. One illumination means 96 or multiple illumination means 96 can be situated adjacent to at least one lateral side portion of the exit slot 88. One continuous illumination means 96 may be situated in proximity to an entire perimeter of the exit slot 88. Alternatively, multiple spaced apart illumination means 96 may be situated in proximity to the entire perimeter of the exit slot 88.

In the illustrated embodiment, at least one illumination means 96 is situated along the longitudinal side of the exit slot 96 that is closer to a middle width portion of the undersurface 86. More specifically, the illumination means 96 is situated close to a center plane (or center line CL) bisecting the containment space 14 across its longitudinal extent (see FIG. 6). This center line is generally between adjacent lengths of the motor 72 and the cutter assembly 70.

It is anticipated that the cutter assembly 70 is positioned in the head assembly 16 closer to a second longitudinal wall 40 and, more specifically, farthest from a front of the shredder device 10. The cylinders 76 are housed in the header assembly 16 farthest from the access 32 so that they are less reachable during instances when the bin assembly 12 is removed from the cabinet 26. In this manner, the chad is falling in close proximity to a rear region of the bin receptacle 12 (i.e., a farther region) relative to the front sidewall 38 when the shredder device is operating. Therefore, the illumination means 96 selectively illuminates to provide the user viewing of the rear regions of the containment space 14. The illumination means 96 situated along the center line CL direct light downwardly on top of the chad pile such that the entire pile is illuminated.

In one embodiment, at least one illumination means 96 may be positioned along the longitudinal side of the exit slot 88 situated farthest away from the front sidewall 38 so that the falling chad is illuminated from behind.

In this manner, it is anticipated that both the illumination means 96 disclosed herein and the transparent surface region enable a user to make a visual determination as to whether a containment space 14 defined by a bin receptacle 12 is at full capacity. One aspect of the present disclosure is a reduced number of advanced components which therefore unnecessarily drive the costs of manufacture up.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A fragmentation device, comprising:
a bin, including:
at least one continuous wall extending upwardly from a bottom surface, and,
a containment space defined by the at least one wall and bottom surface;
an adjacent fragmentation assembly adjacent an entrance to the bin; and,
an illumination means situated in proximity to an exit slot of the fragmentation assembly and the entrance of the bin, the illumination means directing at least one light beam downwardly into the containment space.

2. The fragmentation device of claim 1, wherein the bin further includes a transparent surface region situated in the at least one wall for viewing the containment space.

3. The fragmentation device of claim 1, wherein the fragmentation assembly is included in a support housing, the support housing further including:
a feed slot for feeding an associated article to the fragmentation device;
a motor drive assembly for driving the fragmentation device; and,
at least one piercing mechanism for piercing and separating the associated article into multiple fragments;
wherein the associated multiple fragments collect in the containment space.

4. The fragmentation device of claim 3, wherein the fragmentation assembly further includes:
a sensor for detecting a presence of the associated article as it enters the feed slot; and,
a controller operatively associated with the sensor and the illumination means;
wherein the controller illuminates the illumination means when the sensor generates a signal indicating the presence of the associated article in the feed slot.

5. The fragmentation device of claim 3, wherein the fragmentation assembly further includes a controller operatively associated with the motor drive assembly and the illumination means, wherein
the controller illuminates the illumination means when the motor drive assembly is energized.

6. The fragmentation device of claim 1, wherein the illumination means includes at least one LED.

7. The fragmentation device of claim 6, wherein the at least one LED operate at a wavelength range of from about 440 to about 490 nanometers.

8. The fragmentation device of claim 6, wherein the at least one LED is blue.

9. The fragmentation device of claim 8, wherein the at least one LED operates at a hue value of approximately 240°.

10. A shredder appliance for shredding at least one generally planar media sheet, comprising:
a bin, including:
a containment space formed by a bottom wall and at least one generally upwardly extending sidewall connected thereto, and,
at least one transparent region formed through the at least one wall;
a head assembly, including:
a cutter assembly including at least one cutter for shredding the media sheet,
a feed path extending from an exterior of the cutter assembly to the bin, the feed path including a feed slot portion for guiding the media sheet to the cutter assembly, the feed path extending adjacent to the at least one cutter, and the feed path terminating at an opening to the bin, and,
a drive assembly for translating movement of the at least one cutter; and,
a light selectively activated to illuminate the bin at least a duration simultaneous to when the drive assembly is energized.

11. The shredder appliance of claim 10, further including a sensor situated in proximity to the feed slot portion of the feed path, the sensor activating when the media sheet is present in the feed slot, wherein the light selectively illuminates the bin when the sensor is activated.

12. The shredder appliance of claim 11, wherein the light selectively activates when the sensor detects the media sheet in the feed path and deactivates when the driver assembly is deenergized.

13. The shredder appliance of claim 10, wherein the light is situated in proximity to the feed path at the opening of the bin, the light being directed downwardly past toward the bottom wall and in proximity to a containment space portion situated adjacent to the transparent region.

14. The shredder appliance of claim 10, wherein the light includes multiple light emitting diodes.

15. The shredder appliance of claim 14, wherein the light emitting diodes operate in a wavelength range at least greater than 440 nanometers.

16. The shredder appliance of claim 14, wherein the light emitting diodes operate in a wavelength range at least less than 490 nanometers.

17. The shredder appliance of claim 14, wherein a color of light emitted by the light emitting diodes is blue.

18. A media shredder device, comprising:
a bin including a closed containment space defined by a bottom wall and at least one sidewall extending upwardly therefrom;
an exit slot to the containment space situated at a height generally above the sidewall;
an LED illuminant situated above the containment space and in proximity to the exit slot, the LED selectively emitting light downwardly into the containment space;
wherein the LED operates at a wavelength of at least 440 nanometers.

19. The shredder device of claim 18, wherein the LED operates at a wavelength no greater than 490 nanometers.

20. The shredder device of claim 18, further including a controller selectively activating the LED illuminant at times the shredder is operative.
